(19) United States
(12) Patent Application Publication
(10) Pub. No.: US 2007/0008063 A1
(43) Pub. Date: Jan. 11, 2007

(54) Rotary actuator with non-contacting position sensor

(75) Inventors: Donald R. Lawrence, Etobicoke (CA); Yulanda Wang, Mississauga (CA); Florin Perieteanu, Mississauga (CA); Steven R. Mitchell, Niles, MI (US)

Correspondence Address: CTS CORPORATION, 905 W. BLVD. N, ELKHART, IN, 46514, US

(73) Assignee: CTS Corporation

(21) Appl. No.: 11/520,292

(22) Filed: Sep. 13, 2006

Related U.S. Application Data
(63) Continuation-in-part of application No. 10/917,741, filed on Aug. 13, 2004, now Pat. No. 7,116,210.
(60) Provisional application No. 60/749,531, filed on Dec. 12, 2005.

(51) Int. Cl. H01C 10/14

(52) U.S. Cl. 338/116

(57) ABSTRACT

An actuator and integral position sensor has increased reliability with a fail-safe mode. An electric motor has a shaft. A sensor is mounted to the electric motor. The sensor has a housing and a rotor. The rotor has a bore and first and second recesses. The recesses have different depths. The shaft is engaged with the bore. A first magnet is mounted in the first recess and a second magnet is mounted in the second recess. A magnetic field sensor is mounted adjacent the rotor.

### CROSS REFERENCE TO RELATED AND CO-PENDING APPLICATIONS

The present patent application is a continuation-in-part of U.S. patent application Ser. No. 10/917,741, filed Aug. 13, 2004 and titled, “Actuator with Integral Position Sensor”.

The present patent application claims priority to U.S. provisional patent application Ser. No. 60/749,531, filed Dec. 12, 2005 and titled, “Rotary Actuator with Non-Contacting Position Sensor”.

The foregoing pending applications are herein incorporated by reference in their entirety.

### BACKGROUND

The present invention relates to actuators in general and in particular to a rotary actuator with an integral position sensor.

Prior actuators combined with position sensors have sensed the position of the actuator and not the device that is to be moved by the actuator. Unfortunately, in the case where there is a failure in the mechanical link between the actuator and the driven device, the position of the driven device is unknown. The position sensor coupled to the actuator will continue to report the position of the actuator even when the driven device is in a different location. Such a situation is undesirable and can be dangerous in certain applications.

An unmet need exists for an actuator with an integral position sensor that has increased reliability and is fail safe.

### SUMMARY OF THE INVENTION

It is a feature of the present invention to provide an actuator with an integral position sensor.

It is a feature of the present invention to provide an actuator with an integral position sensor that has increased reliability and that has a fail safe mode.

Another feature of the present invention to provide an actuator and sensor assembly that includes a rotary actuator that has a driving shaft extending therefrom. A rotor has a first bore, a first flange, a second bore, a second flange and a groove. The first bore is coaxial with the second bore. The driving shaft is mounted in the first bore and is engaged with the first flange such that rotation of the driving shaft rotates the rotor. A contactor is mounted to an outer edge of the rotor. The contactor is engaged with the resistor film as the rotor rotates. The contactor and resistor film form a variable resistor. A driven shaft is mounted in the second bore and is engaged with the second flange. The rotor couples the driving shaft and the driven shaft together.

An additional feature of the present invention is to provide an assembly that includes an electric motor with a shaft. A sensor is mounted to the electric motor. The sensor has a housing with a cavity. A rotor is mounted in the cavity. The rotor has a bore and a first and second recess. The recesses have different depths. The shaft is engaged with the bore. A first magnet is mounted in the first recess and a second magnet is mounted in the second recess. A magnetic field sensor is mounted adjacent to the rotor for sensing a magnetic field generated by the magnets.

### BRIEF DESCRIPTION OF THE DRAWINGS

FIG. 1 is a perspective view of an actuator and sensor assembly.

FIG. 2 is an exploded view of the actuator and sensor assembly of FIG. 1.

FIG. 3 is an enlarged view of the sensor portion of FIG. 2.

FIG. 4 is a cross-sectional view of the actuator and sensor assembly of FIG. 1.

FIG. 5 is a perspective view of the inside of the sensor housing and resistor film.

FIG. 6 is a perspective view of an alternative embodiment of an actuator and non-contacting sensor assembly.

FIG. 7 is an exploded view of the actuator and sensor assembly of FIG. 6.

FIG. 8 is a cross-sectional view of FIG. 6.

FIG. 9 is a perspective view of a rotor.

FIG. 10 is another perspective view of a rotor.

FIG. 11 is a cross-sectional view of the rotor of FIG. 9.

FIG. 12 is a perspective view of a magnet.

It is noted that the drawings of the invention are not to scale. In the drawings, like numbering represents like elements among the drawings.

### DETAILED DESCRIPTION

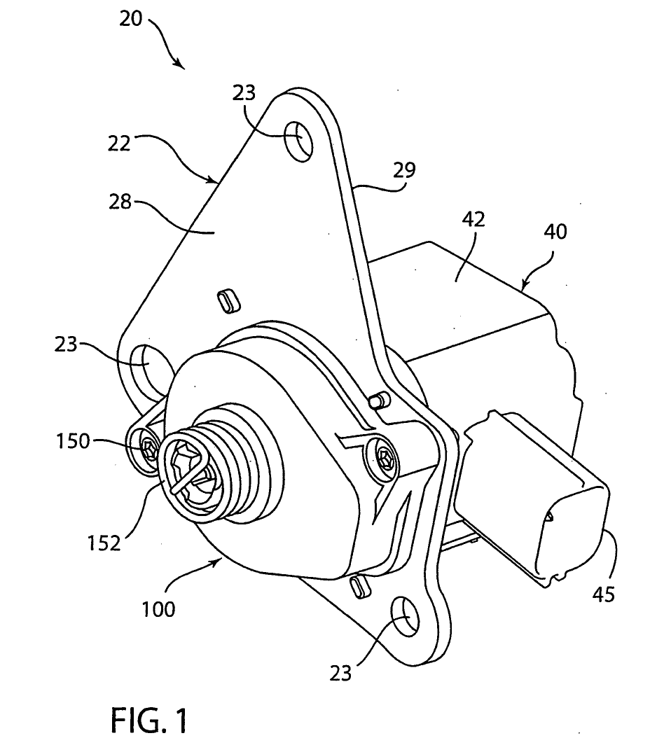

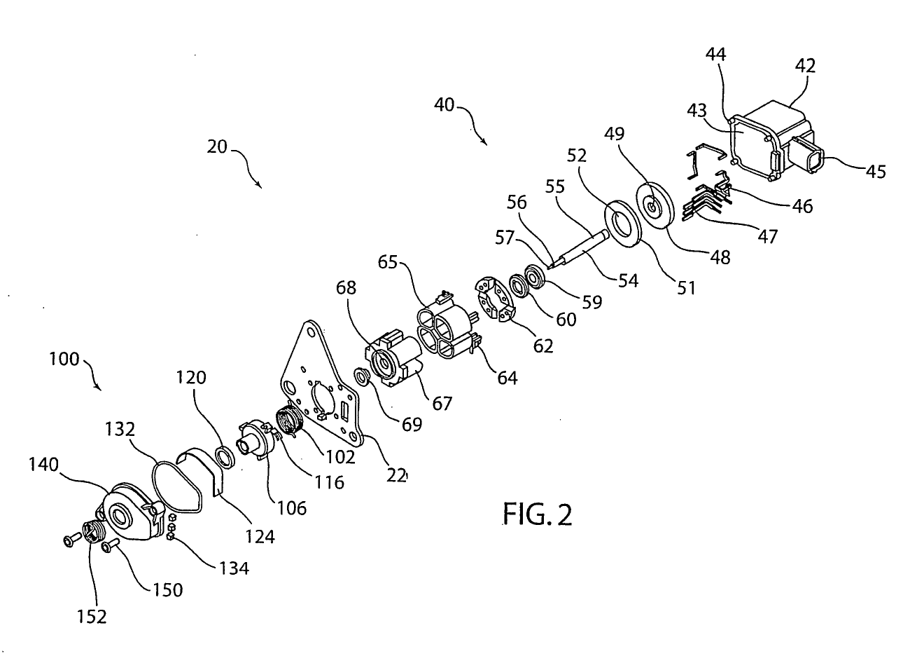

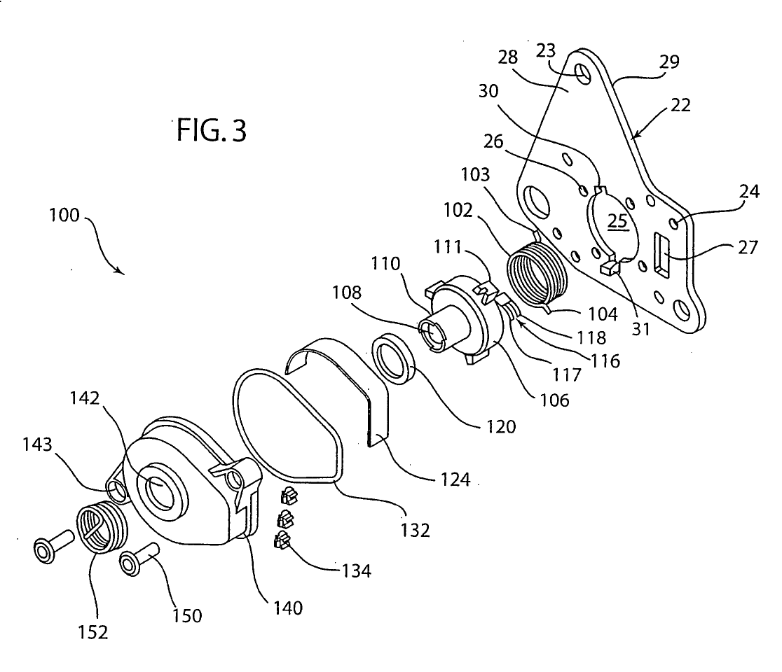

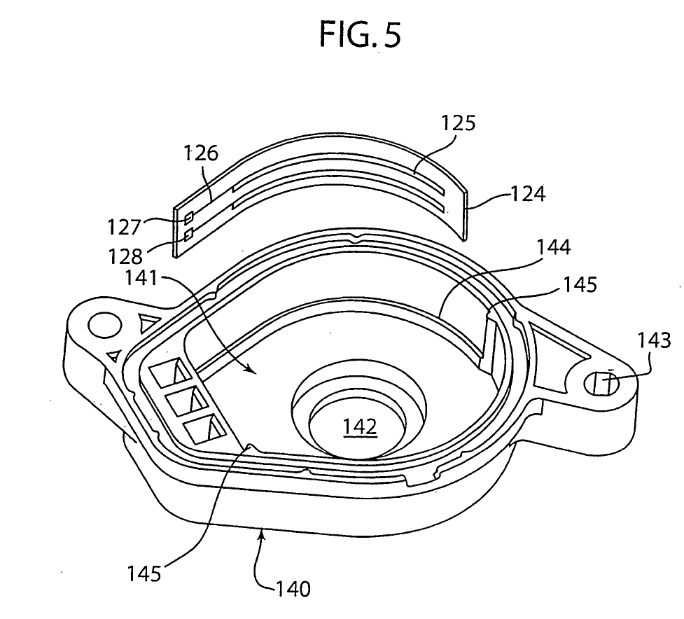

Referring to FIGS. 1-5, an embodiment of an actuator and sensor assembly 20 is shown. Actuator and sensor assembly 20 has an actuator 40 and a sensor 100. A bracket 22 is located between actuator 40 and sensor 100. Bracket 22 has a manifold mounting hole 23, a sensor mounting hole 24, a shaft hole 25, an actuator mounting hole 26, a slot 27, a side 28, a side 29, a notch 30 and a tab 31. Actuator 40 is mounted on side 29. Sensor 100 is mounted on side 28. Bracket 22 is mounted to an intake manifold 200 of an internal combustion engine. Screws 204 are fastened through manifold mounting holes 23 to hold assembly 200 to intake manifold 200.

Actuator

Actuator or electric motor 40 is a electro-mechanical stepper motor that has a high ratio of torque per mass and torque per power draw. Actuator 40 also has a magnetic circuit that allows a significant holding torque while using a limited amount of electric power.

Actuator 40 has a housing 42. Housing 42 has a cavity 43, pins 44 that extend from one end of housing 42 and a connector flange 45. Actuator terminals 46 are mounted in cavity 43. One end of terminals 46 are located in connector flange 45 and the other ends are located in cavity 43. Sensor terminals 47 are mounted in cavity 43. One end of terminals 47 are located in connector flange 45 and the other ends extend through slot 27 to sensor 100. A wire harness (not shown) would mate with connector flange 45 to provide power and control signals to actuator 40.

Actuator 40 has soft-magnetic parts that make up the magnetic circuits of the motor, namely: a stator 67 and a rotor 48. Stator 67 has a hole 68. Rotor 48 has a hole 49 and a respective multi-pole magnet 51 that is attached to rotor 48. Magnet 51 has a hole 52 and alternating north and south regions. Poles 62 are mounted to bobbin 64.

A bobbin 64 includes four coils of conventional wire windings 65. By regulating either the direction of current passing through the wire or by changing the direction of the winding of the coils, each column can become a north or south electro-magnet.

A driving shaft or actuator shaft 52 has ends 55 and 56. End 56 is coupled to rotor 49 via a flat portion 57 extending into bore 107. Shaft 52 extends through magnet 51, stator 67 and hole 25. A bearing 59 and bushing 69 support shaft 52. Bearing 59 is retained by a bearing support 60.

Sensor

Sensor 100 is mounted on side 28 of bracket 22. Sensor 100 has a housing 140 that is mounted to bracket 22. Housing 140 has a cavity 141, a hole 142, screw holes 143, slot 144 and posts 145. Screws 150 fasten housing 140 to bracket 22. O-ring 132 forms a seal between bracket 22 and housing 140.

Rotor 106 is mounted inside housing 140. Rotor 106 has a bore 107, 108, groove 109, flange 110 and post 111. Shaft end 56 is mounted in bore 107 with flat 57 engaged with a corresponding area in the bore. Shaft 54 thereby can rotate rotor 106. Primary spring 102 is mounted in groove 109. Primary spring 102 has an end 103 and an end 104. End 103 is held by notch 30 and end 104 is held in groove 109. Spring 102 biases rotor 106 to a fail safe position.

A metal bi-furcated contactor 116 is mounted to post 111. Contactor 116 has ends 117 and 118. Contactor 116 is heat staked to post 111. Contactor 116 can be made out of a precious metal alloy such as Paliney 16. Flange 110 extends through hole 142 of cover 140. Seal 120 is mounted around and seals flange 110.

A polyimide film or element 124 is mounted in slot 144 between posts 145. Film 124 has a pair of resistor tracks 125, a pair of conductors 126 and a pair of contact pads 127 and 128. Clips 134 are pressed over contact pads 127, 128 and sensor terminals 47. The clips make an electrical connection between the contact pads and the sensor terminals. The end 117 of contactor 116 is in contact with one of the resistors 125. The other end 118 is in contact with the other resistor 125.

In operation, as rotor 54 rotates, ends 117 and 118 wipe or slide along resistor tracks creating a potentiometer. A voltage is applied between contact pads 127 and 128, as contactor 116 slides, the voltage drop changes across the resistors and at contact pads 127 and 128. Terminals 47 would be connected to external signal conditioning circuitry. As is well known in the art, the angular position of the actuator can be determined from the voltage level. The external signal conditioning circuitry may be added internally to the sensor, if desired.

Actuator and Sensor Mounting

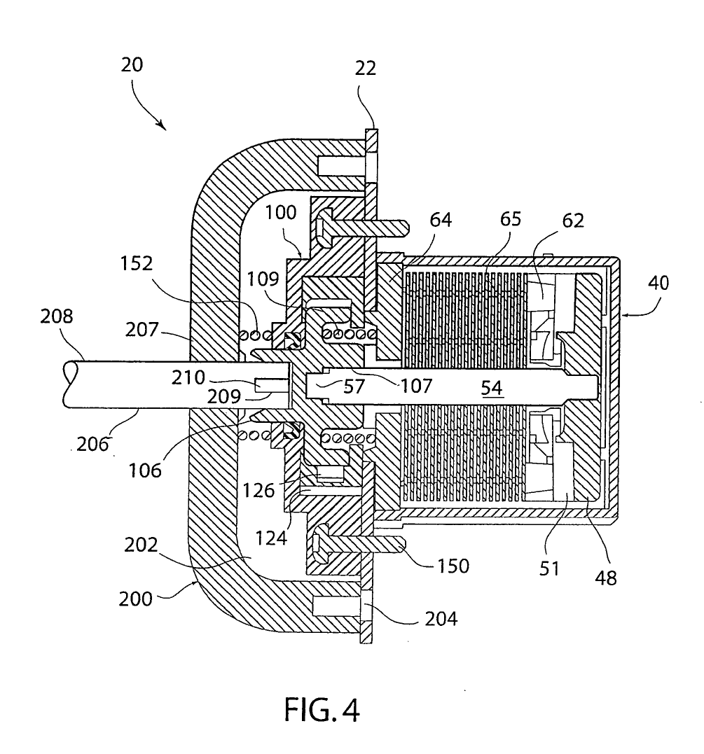

Referring to FIG. 4, actuator and sensor assembly 20 is shown mounted to an intake manifold 200 of an internal combustion engine. Manifold 200 has a cavity 200. Screws 204 are used to attached manifold 200 to bracket 22. A driven shaft or manifold valve shaft 206 has ends 207, 208 and a notch 209. End 207 is retained and held in bore 108. End 207 can be held by a metal flat portion 210 in bore 108 engaging notch 209. Manifold value shaft 206 would be attached to a valve or valves (not shown) in runners of an intake manifold. The purpose of the valves is to increase mixing and atomization of the fuel/air mixture. A secondary spring 152 is mounted around flange 110 between housing 140 and intake manifold 200. Secondary spring 152 is attached to rotor 106. Spring 152 biases rotor 106 to a fail safe position.

In the event of a failure of shaft 54 or 206, springs 102 and 152 will bias rotor 106 such that contactor 116 is disengaged from resistors 125 resulting in an open circuit with zero voltage. This mode is shown in FIG. 4 where the contactor does not touch film 124. An engine controller can be programmed to read the zero voltage output from the sensor and respond by controlling the engine in an appropriate manner.

Discussion

One of ordinary skill in the art of designing and using actuators and sensors will realize many advantages from using the present invention. The use of two shafts, one connected to each side of the sensor, provides for a fail-safe sensor that always reads the true position of the valve shaft.

An additional advantage of the present invention is in case of a failure of either shaft, the rotor will rotate such that the contactors are disengaged from the resistors resulting in an open circuit with zero voltage. An engine controller can be programmed to read the zero voltage output from the sensor and respond by controlling the engine in an appropriate manner.

Another advantage of the present invention is that the sensor is well sealed from environmental contamination.

Another advantage of the present invention is that the sensor is not only connected to the actuator but is connected to the object whose position is desired to be sensed.

Non-Contacting Sensor Embodiment

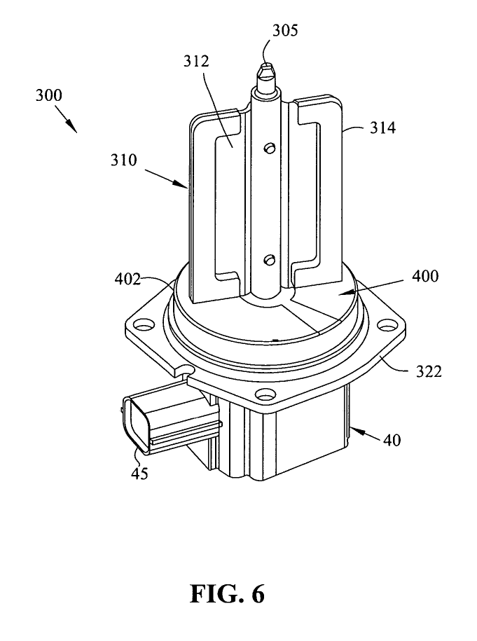

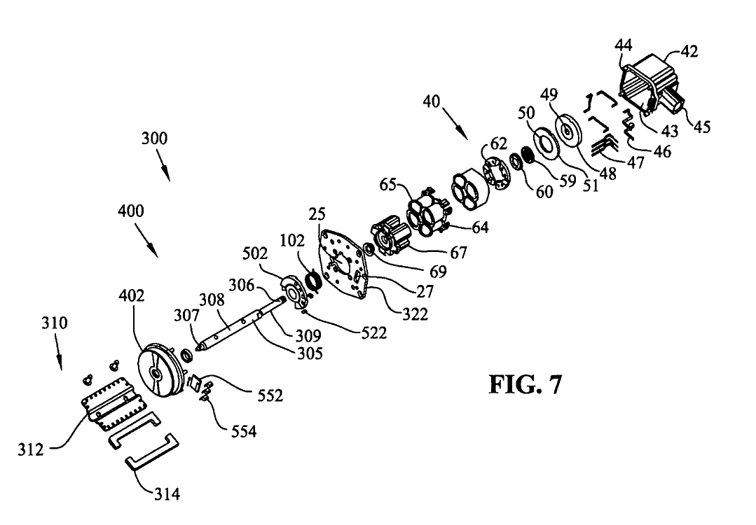

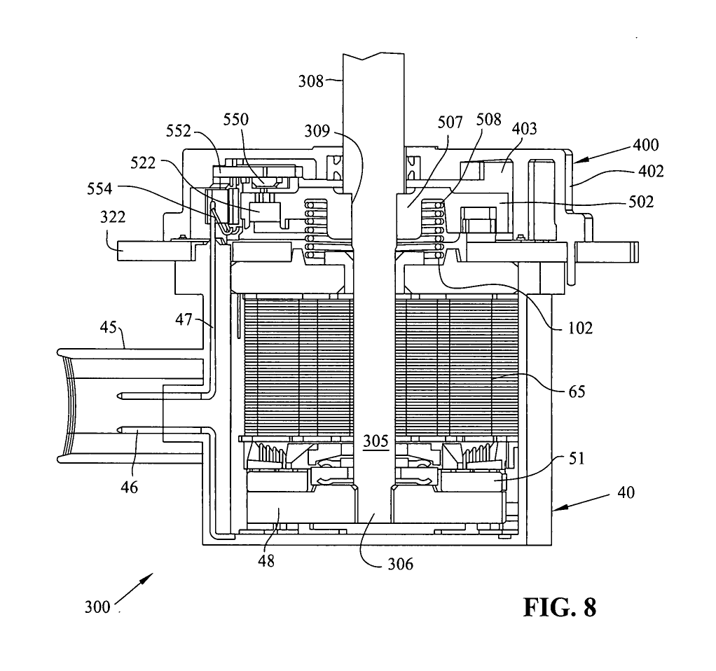

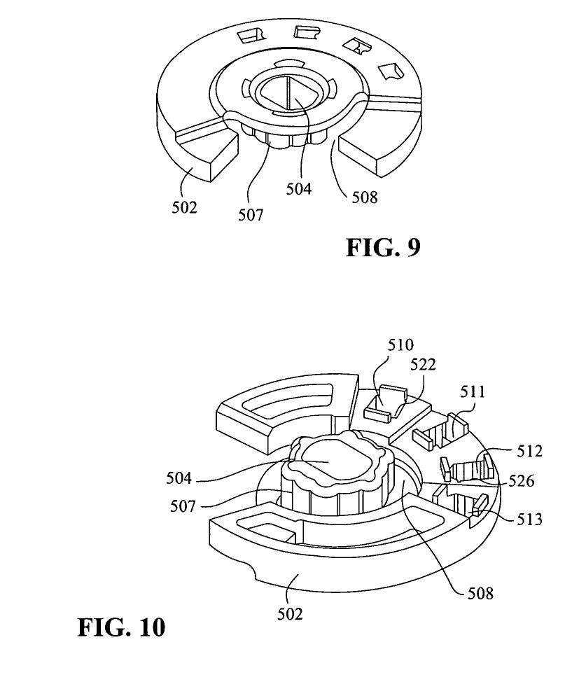

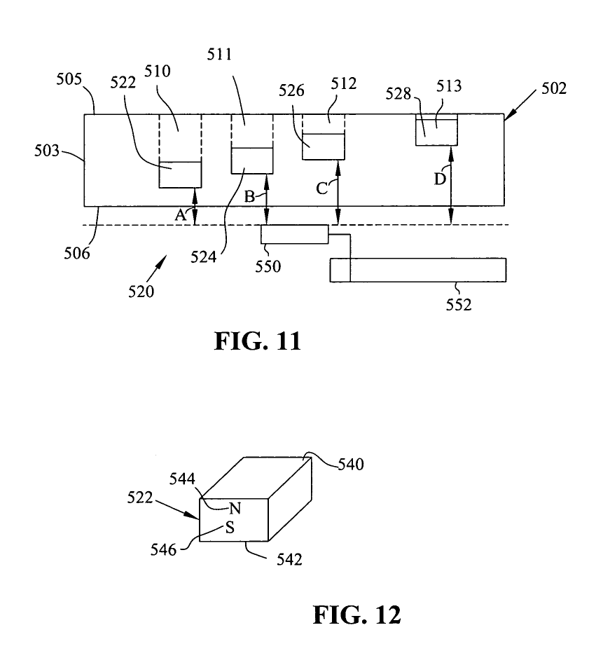

Referring to FIGS. 6-12, an alternative embodiment of an actuator and non-contacting sensor assembly 300 is shown. Actuator and sensor assembly 300 has an actuator 40 and a sensor 400. Actuator 40 was previously described. A bracket 322 is located between actuator 40 and sensor 400. Bracket 322 would be mounted to an intake manifold 200 (see FIG. 4) of an internal combustion engine. A valve 310 is mounted to shaft 305. Valve 310 has a plate 312 and a seal 314. Valve 310 would be located inside of an intake manifold and can be opened and closed in order to adjust the agitation, mixing and flow of air inside the intake manifold. Seal 314 can provide a seal between the valve and the interior surface of the intake manifold.

Shaft 305 has ends 306 and 307. Shaft 305 further has valve mounting section 308 and a rotor mounting section 309. Valve 310 is mounted to valve mounting section 308 using screws or rivets. Rotor 502 is mounted to rotor mounting section 309. End 306 is located within actuator 40 and is attached to actuator rotor 48.

Sensor 400 has a housing 402 that is mounted to bracket 322. Housing 402 has a cavity 403. A rotor 502 is mounted inside housing 400 in cavity 403. Rotor 502 has a bore 504, outer surface 503, top side 505 and bottom side 506. Rotor 502 also has a flange 507 and a groove 508. Coil spring 102 is mounted in groove 508 around flange 507. Spring 102 biases rotor 502 toward a starting or rest position.

Rotor 502 also has recesses 510, 511, 512 and 513. Recesses 510, 511, 512 and 513 are designed such that they have different depths to side 505 or heights above bottom side 506. Magnet 522 is mounted in recess 510. Magnet 524 is mounted in recess 511. Magnet 526 is mounted in recess 512. Magnet 528 is mounted in recess 513. Magnets 522, 524, 526 and 528 can all have the same shape, are made out of the same material and have the same magnetic field strength. The magnets can be made out of bonded ferrite or neodymium iron boron. The magnets have a top side 540, a bottom side 542, north pole 544 and south pole 546.

A magnetic field sensor 550 such as a hall effect device is mounted adjacent rotor side 506. Magnetic field sensor 550 is mounted to a printed circuit board 552. Printed circuit board 552 is mounted to housing or cover 402. Printed circuit board 552 is connected with terminal clips 554, which are electrically connected to terminals 46 and 47.

The magnetic field sensor 550 is able to measure the strength and polarity of the magnetic field generated by the magnets. The recesses 510, 511, 512 and 513 in rotor 502 cause magnets 522, 524, 526 and 528 to be spaced from sensor 550 by a distance. Magnet 522 is spaced from sensor 550 by a distance A. Magnet 524 is spaced from sensor 550 by a distance B. Magnet 526 is spaced from sensor 526 by a distance C. Magnet 528 is spaced from sensor 550 by a distance D.

Operation

During operation, as shaft 305 is rotated by actuator motor 40, magnets 522, 524, 526 and 528 move with respect to magnetic field sensor 550. Sensor 550 is fixed in position. Sensor 550 generates an electrical signal that is proportional to the magnitude of the magnetic field.

Since, magnet 522 is closer to sensor 550 than the other magnets, the magnetic field is stronger and the electrical signal generated by sensor 550 will be the largest when magnet 522 is rotated such that it is aligned over sensor 550.

Similarly, since, magnet 528 is farthest from sensor 550 than the other magnets, the magnetic field will be weaker and the electrical signal generated by sensor 550 will be the smallest when magnet 522 is rotated such that it is aligned over sensor 550. The output signals for magnets 524 and 526 will be between those of magnets 522 and 528. The angular position of rotor 502 and actuator 40 can be determined from the voltage level of the electrical signal from sensor 550. External signal conditioning circuitry may be connected with sensor 550 for amplification and temperature compensation, if desired.

While the invention has been taught with specific reference to these embodiments, someone skilled in the art will recognize that changes can be made in form and detail without departing from the spirit and the scope of the invention. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An assembly comprising:
an electric motor having a first shaft extending therefrom;
a sensor mounted to the electric motor, the sensor including:
a housing having a cavity;
a rotor mounted in the cavity, the rotor having a bore and a first and second recess, the recesses having differing depths, the first shaft being engaged with the bore;
a first magnet mounted in the first recess;
a second magnet mounted in the second recess; and
a magnetic field sensor mounted adjacent the rotor.

2. The assembly according to claim 1, wherein the magnetic field sensor is mounted to a printed circuit board, the printed circuit board mounted to the housing.

3. The assembly according to claim 1, wherein the rotor has a flange, a spring mounted around the flange, the spring adapted to bias the rotor toward a first position.

4. The assembly according to claim 2, wherein a plurality of terminals are mounted to the printed circuit board.

5. The assembly according to claim 1, wherein a third and fourth recess are located in the rotor.

6. The assembly according to claim 5, wherein a third magnet is mounted in the third recess and a fourth magnet is mounted in the fourth recess.

7. A sensor assembly comprising:
an electric motor having a shaft, the shaft having a first end, the second end extending from the electric motor
a sensor mounted to the second end, the sensor including:
a cover having a cavity, the cover mounted to the electric motor;
a rotor mounted in the cavity, the rotor mounted to the second end, the rotor rotating as the electric motor rotates;
a magnetic field sensor mounted to the cover and spaced from the rotor;
a first magnet mounted to the rotor and spaced a first distance from the magnetic field sensor; and
a second magnet mounted to the rotor and spaced a second distance from the magnetic field sensor;

8. The sensor assembly according to claim 7, wherein the rotor has a first recess and a second recess.

9. The sensor assembly according to claim 8, wherein the first magnet is mounted in the first recess and the second magnet is mounted in the second recess.

10. The sensor assembly according to claim 8, wherein a third and fourth recess are located in the rotor.

11. The sensor assembly according to claim 10, wherein a third magnet is mounted in the third recess and a fourth magnet is mounted in the fourth recess.

12. The sensor assembly according to claim 7, wherein the rotor has a flange, a spring mounted around the flange, the spring adapted to bias the rotor toward a first position.

13. A sensor assembly comprising:
rotary motor means for rotating an attached shaft;
first magnet means mounted to the shaft for generating a first magnetic field;
second magnet means mounted to the shaft for generating a second magnetic field; and
magnetic field sensor means spaced from the first and second magnet means for sensing the first and second magnetic fields, the magnetic field sensor means generating an electrical signal that is proportional to the magnitude of the sensed magnetic field.

14. The sensor assembly according to claim 13, wherein the first and second magnet means are mounted to a rotor means.

15. The sensor assembly according to claim 14, wherein the rotor means has a first and second recess.

16. The sensor assembly according to claim 15, wherein the first magnet means is mounted in the first recess and the second magnet means is mounted in the second recess.

17. The sensor assembly according to claim 13, wherein the first magnet means is spaced a different distance from the magnetic field sensor means than the second magnet means.

18. The sensor assembly according to claim 13, further comprising a third and fourth sensor means mounted to the shaft.
